(19) United States
(12) Patent Application Publication
(10) Pub. No.: US 2023/0260335 A1
(43) Pub. Date: Aug. 17, 2023

(54) INFORMATION PROCESSING SYSTEM, INFORMATION TERMINAL, INFORMATION PROCESSING METHOD, AND RECORDING MEDIUM

(71) Applicant: HONDA MOTOR CO., LTD., Tokyo (JP)

(72) Inventor: Yuya KISHIMOTO, Saitama (JP)

(73) Assignee: HONDA MOTOR CO., LTD., Tokyo (JP)

(21) Appl. No.: 18/107,732

(22) Filed: Feb. 9, 2023

(30) Foreign Application Priority Data
Feb. 14, 2022 (JP) 2022-020394

(51) Int. Cl. G07C 5/00; G07C 5/08

(52) U.S. Cl. CPC G07C 5/008; G07C 5/0808

(57) ABSTRACT

An information processing system includes: an acquisition processor configured to acquire traveling data of a vehicle; a diagnosis processor configured to perform a driving diagnosis process of the vehicle based on the traveling data acquired by the acquisition processor; a diagnosis information transmitter configured to transmit, to an information terminal of a user of the vehicle, diagnosis information based on a result of the driving diagnosis process performed by the diagnosis processor; and a receiver. The diagnosis information includes request information that requests the user to create a learning content based on a specific event detected in the driving diagnosis process, and the receiver receives the learning content created by the user in response to the request information from the information terminal.

### CROSS-REFERENCE TO RELATED APPLICATIONS

This application is based on and claims priority under 35 USC 119 from Japanese Patent Application No. 2022-020394 filed on Feb. 14, 2022, the contents of which are incorporated herein by reference.

### TECHNICAL FIELD

The present disclosure relates to an information processing system, an information terminal, an information processing method and a recording medium storing an information processing program.

### BACKGROUND ART

In recent years, it is required to improve traffic safety in order to make cities and human settlements inclusive, safe, resilient and sustainable. In related art, there has been proposed a driving assistance system in which a driving assistance server computer and a portable terminal of a driver are connected to each other via the Internet, and education information effective for improving driving of the driver is distributed from the server computer to the portable terminal of the driver (for example, see Japanese Patent Application Laid-Open Publication No. 2019-46079 (hereinafter, referred to as Patent Literature 1)).

According to the driving assistance system in Patent Literature 1, driving information detected by the portable terminal is analyzed, and a corresponding safe driving education content is selected and distributed to the driver, so that it is possible to distribute education information effective for improving driving to each driver even when a driver or a vehicle is changed.

However, since the education information corresponding to each driver is selected and distributed from a plurality of prepared safe driving education contents, the education information may not always be sufficient to improve a learning effect regarding safe driving of the driver.

An object of the present disclosure is to provide an information processing system, an information terminal, an information processing method, and an information processing program capable of improving a learning effect of a driver regarding safe driving of a vehicle.

### SUMMARY

A first aspect of the present disclosure relates to an information processing system including:
an acquisition processor configured to acquire traveling data of a vehicle;
a diagnosis processor configured to perform a driving diagnosis process of the vehicle based on the traveling data acquired by the acquisition processor;
a diagnosis information transmitter configured to transmit, to an information terminal of a user of the vehicle, diagnosis information based on a result of the driving diagnosis process performed by the diagnosis processor; and
a receiver, in which
the diagnosis information includes request information that requests the user to create a learning content based on a specific event detected in the driving diagnosis process, and
the receiver receives the learning content created by the user in response to the request information from the information terminal.

A second aspect of the present disclosure relates to an information terminal carried by a user of a vehicle, including:
a receiver configured to receive diagnosis information based on a result of a driving diagnosis process of the vehicle from an information processing system; and
a transmitter, in which
the diagnosis information includes request information that requests the user to create a learning content based on a specific event detected in the driving diagnosis process, and
the transmitter transmits the learning content created by the user in response to the request information to the information processing system.

A third aspect of the present disclosure relates to an information processing method using an information terminal carried by a user of a vehicle and an information processing system, including:
performing, by the information processing system, a driving diagnosis process of the vehicle based on traveling data of the vehicle, and transmits diagnosis information based on a result of the driving diagnosis process to the information terminal; and
receiving, by the information terminal, the diagnosis information, in which
the diagnosis information includes request information that requests the user to create a learning content based on a specific event detected in the driving diagnosis process, and
the information terminal transmits the learning content created by the user in response to the request information to the information processing system.

A fourth aspect of the present disclosure relates to a non-transitory computer-readable recording medium storing an information processing program for causing a computer of an information processing system to execute a process, the process including:
acquiring traveling data of a vehicle;
performing a driving diagnosis process of the vehicle based on the traveling data;
transmitting, to an information terminal of a user of the vehicle, diagnosis information based on a result of the driving diagnosis process; and
receiving, in which
the diagnosis information includes request information that requests the user to create a learning content based on a specific event detected in the driving diagnosis process, and
the receiving includes receiving the learning content created by the user in response to the request information from the information terminal.

A fifth aspect of the present disclosure relates to a non-transitory computer-readable recording medium storing an information processing program for causing a computer of an information terminal carried by a user of a vehicle to execute a process, the process including:
receiving diagnosis information based on a result of a driving diagnosis process of the vehicle from an information processing system; and
transmitting information to the information processing system, in which
the diagnosis information includes request information that requests the user to create a learning content based on a specific event detected in the driving diagnosis process, and
the transmitting includes transmitting the learning content created by the user in response to the request information to the information processing system.

According to the present disclosure, it is possible to provide the information processing system, the information terminal, the information processing method, and the non-transitory computer-readable recording medium storing the information processing program capable of improving a learning effect of a driver regarding safe driving of a vehicle.

### BRIEF DESCRIPTION OF DRAWINGS

Exemplary embodiment(s) of the present invention will be described in detail based on the following figures, wherein:

FIG. 1 is a configuration diagram showing a vehicle information system including an information processing system according to an embodiment;

FIG. 2 is a block diagram showing the information processing system shown in FIG. 1;

FIG. 3 is a block diagram showing an information terminal shown in FIG. 1;

FIG. 4 is a sequence diagram showing an example of an operation of accumulating a learning content in the vehicle information system;

FIG. 5 is a sequence diagram showing an example of an operation of sharing a learning content in the vehicle information system;

FIG. 6 is a flowchart showing an example of processing of the information terminal.

FIG. 7 is a flowchart showing an example of a driving diagnosis process of the information processing system;

FIG. 8 is a flowchart showing an example of a process of providing a learning content by the information processing system;

FIG. 9 shows an example of a diagnosis standby screen displayed on a touch panel of the information terminal;

FIG. 10 shows an example of a diagnosis information screen displayed on the touch panel of the information terminal;

FIG. 11 shows an example of a learning content creation screen displayed on the touch panel of the information terminal;

FIG. 12 shows an example of a post selection screen displayed on the touch panel of the information terminal;

FIG. 13 shows an example of a sharer selection screen displayed on the touch panel of the information terminal;

FIG. 14 shows an example of a learning content introduction screen displayed on the touch panel of the information terminal;

FIG. 15 shows an example of a posted content screen displayed on the touch panel of the information terminal;

FIG. 16 shows an example of a learning screen displayed on the touch panel of the information terminal;

FIG. 17 shows an example of an evaluation screen displayed on the touch panel of the information terminal; and

FIG. 18 shows an example of an evaluation result screen displayed on the touch panel of the information terminal.

### DESCRIPTION OF EMBODIMENTS

Hereinafter, an embodiment of an information processing system according to the present disclosure will be described with reference to the accompanying drawings.

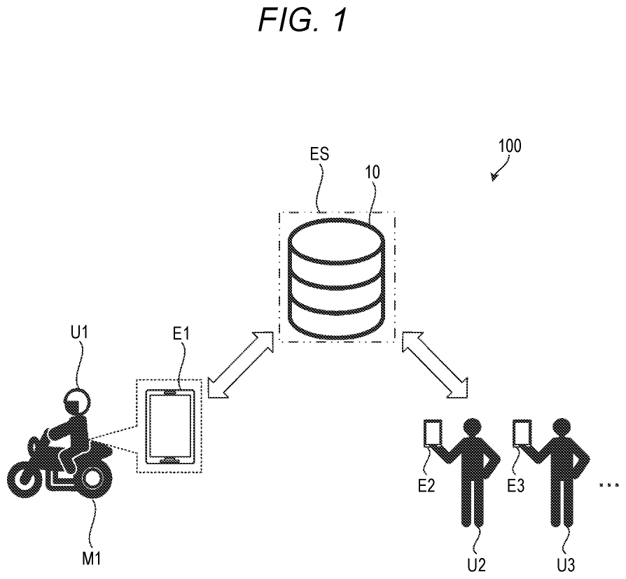

FIG. 1 is a configuration diagram of a vehicle information system 100 including an information processing system 10 according to the embodiment of the present disclosure.

As shown in FIG. 1, the vehicle information system 100 includes the information processing system 10 and information terminals E1, E2, E3, and the like that can be connected to the information processing system 10 via the Internet (public network). The information processing system 10 in the vehicle information system 100 acquires, for example, traveling data of a vehicle M1, and performs a driving diagnosis process related to driving of a user U1 who drives the vehicle M1 based on the acquired traveling data. The information processing system 10 is provided in, for example, an external server ES. The vehicle M1 is, for example, a two-wheeled vehicle driven by the user U1 who is an owner of the vehicle M1. The user U1 owns, for example, the information terminal E1. The information terminal E1 is configured to be carried, for example, when the user U1 gets on the vehicle M1, and to be capable of acquiring the traveling data of the vehicle M1 when the user U1 carrying the information terminal E1 drives the vehicle M1. The traveling data of the vehicle M1 acquired by the information terminal E1 is transmitted to the information processing system 10 via the Internet. Information related to the traveling data of the vehicle M1 accumulated in the information processing system 10 may also be shared by, for example, users U2 and U3 other than the user U1. The users U2 and U3 own the information terminals E2 and E3 having the same functions as those of the information terminal E1 of the user U1. The information related to the traveling data of the vehicle M1 accumulated in the information processing system 10 is transmitted from the information processing system 10 to the information terminals E2 and E3 via the Internet.

### Functional Block Diagram of Information Processing System 10

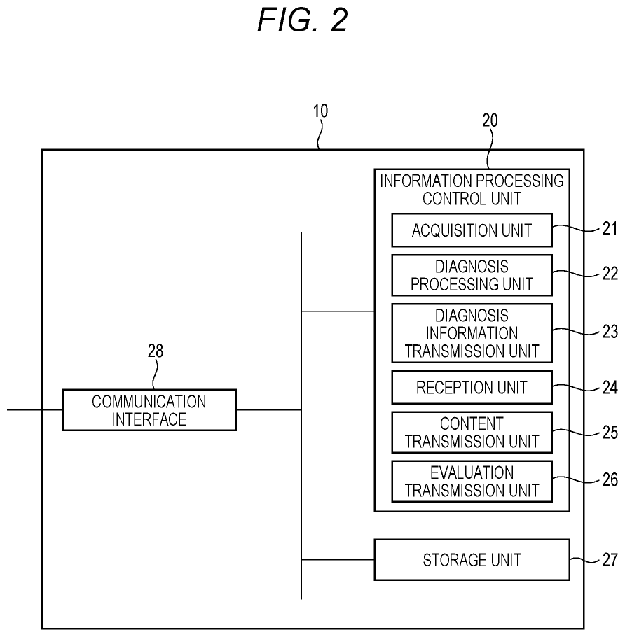

As shown in FIG. 2, the information processing system 10 includes an information processing control unit 20, a storage unit 27, and a communication interface 28. The information processing control unit 20 includes an acquisition unit 21, a diagnosis processing unit 22, a diagnosis information transmission unit 23, a reception unit 24, a content transmission unit 25, and an evaluation transmission unit 26.

The information processing control unit 20 is a circuit that performs signal processing, and includes, for example, a processor such as a central processing unit (CPU) and a memory. The information processing control unit 20 controls the entire information processing system 10 by the processor executing a program read from the memory.

The memory includes, for example, a main memory and an auxiliary memory. The main memory is, for example, a random access memory (RAM). The main memory is used as a work area of the processor. The auxiliary memory is, for example, a nonvolatile memory such as a magnetic disk, an optical disk, or a flash memory. Various programs for operating the information processing system 10 are stored in the auxiliary memory. The programs stored in the auxiliary memory are loaded onto the main memory and executed by the processor.

The acquisition unit 21 acquires the traveling data of the vehicle M1 transmitted from the information terminal E1 of the user U1 via the Internet. The traveling data includes, for example, behavior data of the vehicle and traveling position data of the vehicle. Examples of the behavior data of the vehicle include data such as speed-up/slow-down, acceleration, steering conditions, and vehicle speed of the vehicle. Examples of the traveling position data of the vehicle include data such as position coordinates of the vehicle corresponding to map information.

The diagnosis processing unit 22 performs a driving diagnosis process on a driving content of the user U1 who drives the vehicle M1 based on the traveling data of the vehicle M1 acquired by the acquisition unit 21. Examples of diagnosis information based on a result of the driving diagnosis process performed by the diagnosis processing unit 22 include, for example, information such as a traveling distance, a traveling time, the number of times of sudden braking, the number of times of sudden starting, the number of times of sudden steering, the number of times of lane changing, and a maximum speed of the vehicle M1. The diagnosis information may further include “request information” that requests the user (driver) to create a learning content related to driving based on a “specific event” detected in the driving diagnosis process. The “specific event” includes at least one of dangerous driving of the vehicle and driving for avoiding a dangerous event of the vehicle (danger avoidance driving) that occur during driving of the vehicle driven by the user. Whether an event is the specific event is determined based on, for example, a relationship between a timing of sudden braking and a traveling position of the vehicle, or a relationship between a timing of sudden steering and the traveling position of the vehicle. The learning content includes, for example, various contents for learning that can be reproduced by an information terminal (for example, the information terminals E2 and E3), such as a learning question (a question and an answer thereto) for improving consciousness of safe driving based on the detected dangerous driving or danger avoidance driving of the vehicle, text information literalizing a dangerous situation, illustration information, and voice information. The “request information” requests the driver to create such learning contents.

The danger avoidance driving refers to driving that is not determined to be dangerous driving and is regarded as danger avoidance driving (preventive driving behavior) when behavior data equal to or higher than a threshold value is detected and it is determined based on conditions around the vehicle that the behavior data is a prediction behavior for danger avoidance. Examples of the danger avoidance driving include avoidance of contact with a traffic participant, driving in response to changes in weather conditions and road surface conditions, driving during which sudden braking is applied in advance on the assumption that a pedestrian suddenly comes out, driving during which the vehicle stops (decelerates) in front of an intersection in a case where an end of the intersection is clogged, and driving during which the vehicle stops (decelerates) in a case where an oncoming vehicle is about to turn right at an intersection.

The diagnosis information transmission unit 23 transmits the diagnosis information generated by the diagnosis processing unit 22 to the information terminal E1 of the user U1 of the vehicle M1 via the Internet. The user U1 who receives the diagnosis information creates the learning content based on the specific event in response to the request information included in the diagnosis information, for example, while recalling driving conditions related to the request information.

The reception unit 24 receives the learning content created by the user U1 in response to the request information from the information terminal E1 of the user U1 via the Internet.

The content transmission unit 25 transmits, via the Internet, the learning content received by the reception unit 24 to an information terminal (for example, information terminal E2 or E3) of a user (for example, user U2 or U3) different from the user U1 who creates the learning content. The different user to which the learning content created by the user U1 is transmitted includes, for example, a user who is scheduled to travel by a vehicle along a route corresponding to an occurrence location of the specific event during driving of the user U1. The corresponding route may include not only a route passing through the occurrence location but also a route passing through the vicinity of the occurrence location. The different user further includes, for example, a user driving a vehicle whose type is identical or similar to that of the vehicle M1 of the user U1. The different user further includes a user whose driving tendency is identical or similar to that of the user U1. The driving tendency of the user may be determined based on age, sex, personality, and the like of each user registered in advance, or may be automatically determined based on various types of accumulated information of various users. The user U2 or U3 that receives the learning content, for example, evaluates the learning content and transmits an evaluation result to the information processing system 10.

The reception unit 24 receives the evaluation result with respect to the learning content transmitted from the user U2 or U3. When the evaluation result of the user U2 or U3 with respect to the learning content satisfies a predetermined condition (for example, high evaluation), the evaluation transmission unit 26 transmits the evaluation result to the information terminal E1 of the user U1.

In the storage unit 27, for example, information on the information terminal E1 and the user U1 who is an owner of the information terminal E1, information on the information terminal E2 and the user U2 who is an owner of the information terminal E2, and information on the information terminal E3 and the user U3 who is an owner of the information terminal E3 are registered in association with each other. The information on the users U1, U2, and U3 includes, for example, address, age, sex, personality of the user, a type of a driven vehicle, frequently-used traveling routes, and personality of the user determined based on past traveling data.

The communication interface 28 is a communication interface configured to communicate with the information terminals E1, E2, and E3 via the Internet.

### Functional Block Diagram of Information Terminals E1, E2, and E3

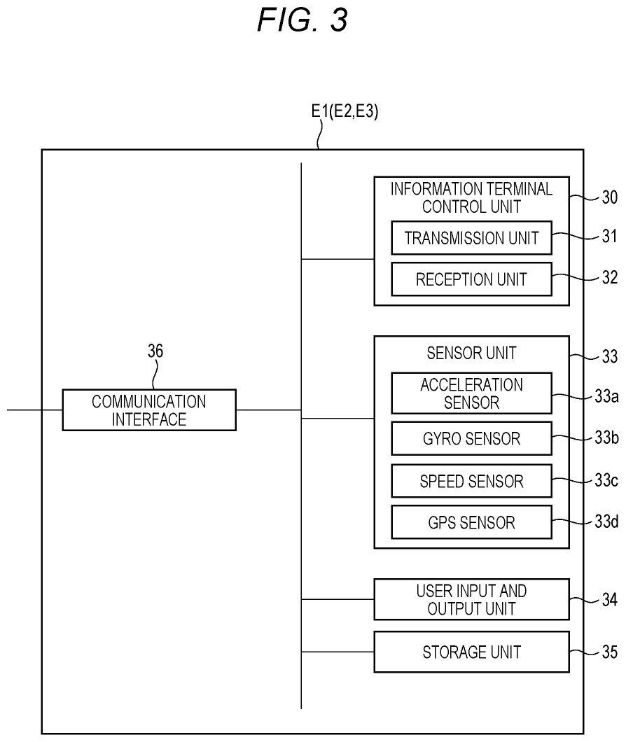

As shown in FIG. 3, the information terminal E1 (E2, E3) includes an information terminal control unit 30, a sensor unit 33, a user input and output unit 34, a storage unit 35, and a communication interface 36. The information terminal control unit 30 includes a transmission unit 31 and a reception unit 32. The sensor unit 33 includes an acceleration sensor 33a, a gyro sensor 33b, a speed sensor 33c, a global positioning system (GPS) sensor 33d, and the like. The information terminal E1 (E2, E3) is a smartphone, a tablet terminal, or the like.

The information terminal control unit 30 is a circuit that performs signal processing, and includes, for example, a processor such as a CPU, and a memory. The information terminal control unit 30 controls the entire information terminal E1 (E2, E3) by the processor executing a program read from the memory. The memory includes, for example, a main memory and an auxiliary memory. The main memory is implemented by, for example, a RAM, and is used as a work area of the processor. The auxiliary memory is, for example, a nonvolatile memory such as a magnetic disk, an optical disk, or a flash memory. Various programs for operating the information terminal E1 (E2, E3) are stored in the auxiliary memory. The programs stored in the auxiliary memory are loaded onto the main memory and executed by the processor.

The acceleration sensor 33a of the sensor unit 33 detects acceleration of the vehicle by measuring an inertial force acting during speed-up or slow-down of the vehicle. The gyro sensor 33b detects angular velocity of a steering wheel by measuring a Coriolis force when the steering wheel of the vehicle is operated. The speed sensor 33c detects a traveling speed of the vehicle. The GPS sensor 33d detects a traveling position of the vehicle by detecting position information on the information terminal E1 (E2, E3) based on a GPS signal.

The user input and output unit 34 includes, for example, an input device that receives an operation input from a user U, and an output device that outputs information to the user U. The input device can be implemented by, for example, a touch panel on a terminal display unit of the information terminal E1 (E2, E3). The output device can be implemented by, for example, the terminal display unit (touch panel) or a speaker of the information terminal E1 (E2, E3).

The information terminal control unit 30 generates the traveling data of the vehicle based on the behavior data of the vehicle and the traveling position data of the vehicle detected by the sensor unit 33. The information terminal control unit 30 further generates the learning content related to the specific event according to an operation signal input by the user U1 through operating the touch panel of the user input and output unit 34 in response to the request information in the diagnosis information generated by the diagnosis processing unit 22 of the information processing system 10. The information terminal control unit 30 further generates the evaluation result with respect to the learning content according to an operation signal input by the user U2 or U3 through operating the touch panel of the user input and output unit 34 in response to the learning content of the user U1 transmitted from the information processing system 10.

The transmission unit 31 transmits the traveling data of the vehicle generated based on detection data of the sensor unit 33 to the information processing system 10 via the Internet. The transmission unit 31 further transmits, to the information processing system 10 via the Internet, the learning content related to the specific event generated in response to the request information. The transmission unit 31 further transmits the evaluation result generated with respect to the learning content to the information processing system 10 via the Internet.

The reception unit 32 receives the diagnosis information generated by the diagnosis processing unit 22 of the information processing system 10 from the information processing system 10 via the Internet. The reception unit 32 further receives, from the information processing system 10 via the Internet, a predetermined learning content selected from learning contents accumulated in the information processing system 10. The reception unit 32 further receives, from the information processing system 10 via the Internet, a predetermined evaluation result among evaluation results with respect to the learning contents accumulated in the information processing system 10.

In the storage unit 35, for example, the traveling data of the vehicle acquired when each user (including the users U1, U2, and U3) drives the vehicle is stored in association with a traveling date and time. In addition, the learning content created by the user who drives the vehicle and the evaluation result created by the other users with respect to the learning content are stored. In addition, a map information database is stored in the storage unit 35.

The communication interface 36 is a communication interface configured to communicate with the information processing system 10 via the Internet.

In the information terminal E1 (E2, E3), an application capable of transmitting and receiving the learning content information created based on the traveling data of the vehicle to and from the information processing system 10 is installed. This application is stored in the information processing system 10, for example, and can be downloaded from the information processing system 10 to the information terminal E1 (E2, E3) via the Internet.

### Operation of Accumulating Learning Content in Vehicle Information System 100

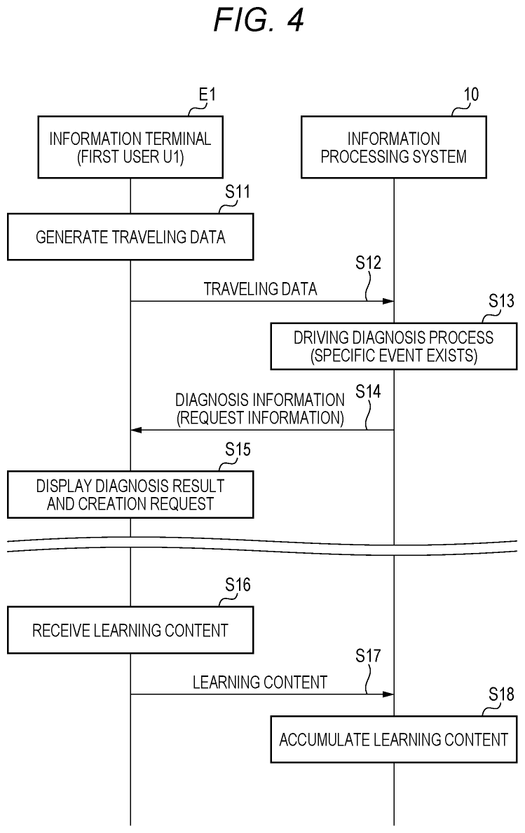

Next, an example of an operation of accumulating a learning content in the vehicle information system 100 will be described with reference to a sequence diagram in FIG. 4.

The operation of accumulating the learning content in the vehicle information system 100 is started, for example, when driving and traveling of the user U1 in the vehicle M1 end. The end of driving and traveling is a time when the user U1 arrives at a destination. The arrival at the destination is, for example, arrival at a traveling destination input in advance before the traveling is started.

The information terminal E1 carried by the user U1 generates the traveling data of the vehicle M1 based on the behavior data and the traveling position data of the vehicle M1 detected by the sensor unit 33 (step S11). The information terminal E1 transmits the generated traveling data of the vehicle M1 to the information processing system 10 (step S12).

The information processing system 10 performs a driving diagnosis process on driving of the user U1 based on the traveling data of the vehicle M1 received in step S12 (step S13). In the present example shown in the drawing, a case in which, as a result of the driving diagnosis process, the specific event (for example, dangerous driving or danger avoidance driving) is included in the diagnosis information based on the result of the driving diagnosis process will be described below. The information processing system 10 transmits, to the information terminal E1, the diagnosis information including the request information that requests the user U1 to create the learning content related to driving based on the specific event (step S14).

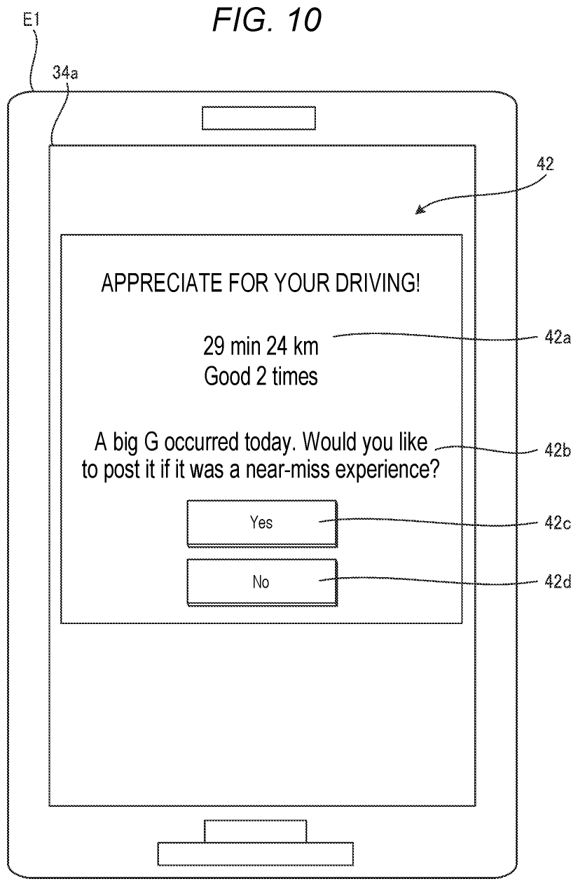

The information terminal E1 receives the diagnosis information from the information processing system 10 in step S14, and displays, on a touch panel, the result (diagnosis result) of the driving diagnosis process in the diagnosis information and the request information (creation request) that requests creation of the learning content based on the specific event in the diagnosis information (step S15). The diagnosis information displayed on the touch panel will be described later with reference to FIG. 10.

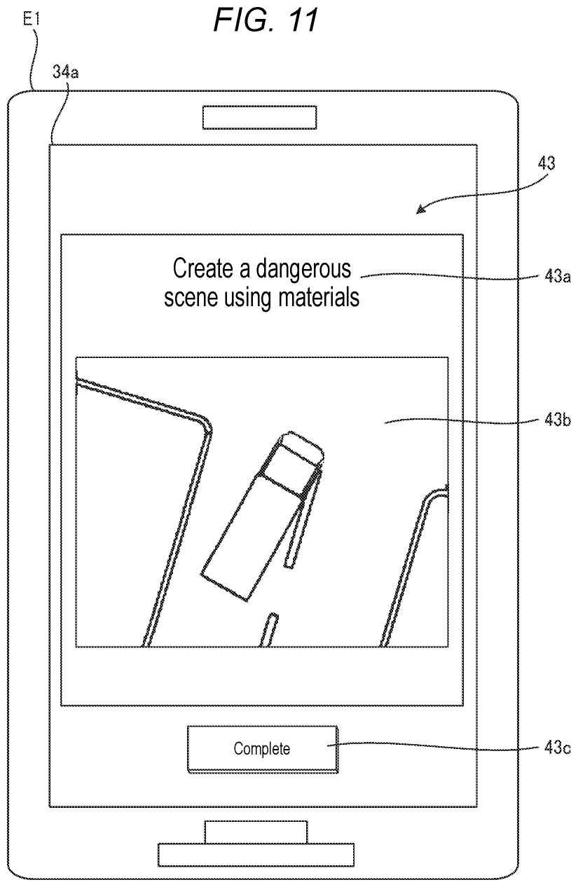

Here, it is assumed that, for example, the user U1 completes the creation of the predetermined learning content in response to the creation request of the learning content in the diagnosis information displayed on the information terminal E1 in step S15. The creation of the learning content will be described later with reference to FIG. 11.

The information terminal E1 receives the created learning content as a learning content to be posted to the information processing system 10 (step S16). The information terminal E1 transmits the learning content received in step S16 to the information processing system 10 (step S17).

The information processing system 10 accumulates the learning content received in step S17 in the storage unit 27 (step S18).

### Operation of Sharing Learning Content in Vehicle Information System 100

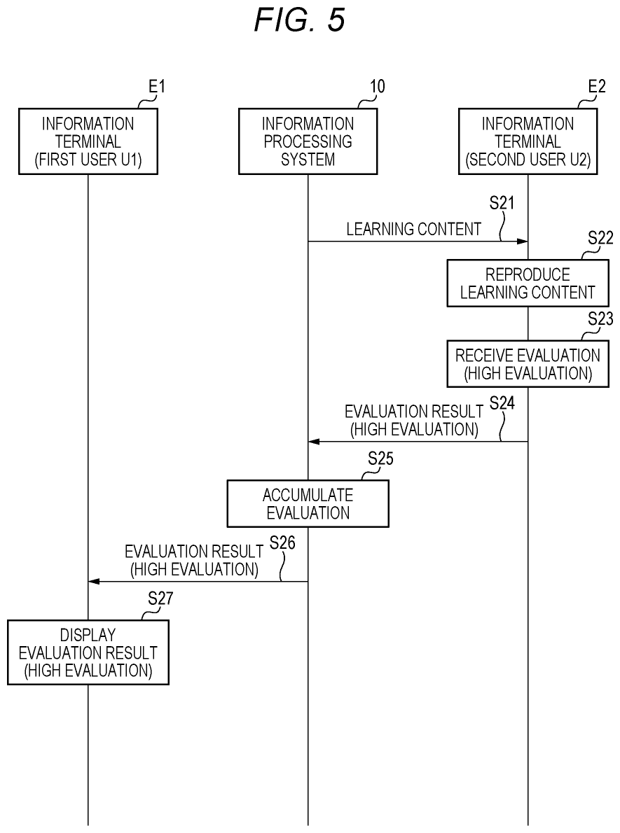

Next, an example of an operation of sharing a learning content in the vehicle information system 100 will be described with reference to a sequence diagram in FIG. 5.

The operation of sharing the learning content in the vehicle information system 100 is started, for example, when a request for the learning content is made from the information terminal E2 of the user U2 or the information terminal E3 of the user U3 after the operation of accumulating the learning content in FIG. 4 described above. The case where the request for the learning content is made refers to, for example, a case where the user U2 or the user U3 inputs a traveling destination to the information terminal E2 or E3 carried by the user U2 or the user U3 and the input information is transmitted from the information terminal E2 or E3 to the information processing system 10 before the user U2 or the user U3 starts driving the vehicle and traveling. In the present example shown in the drawing, a case where the request for the learning content is made from the information terminal E2 of the user U2 will be described below.

The information processing system 10 selects the learning content to be provided to the user U2 from the learning contents accumulated in the storage unit 27, and transmits the selected learning content to the information terminal E2 of the user U2 (step S21).

The information terminal E2 of the user U2 reproduces the learning content received in step S21 on a touch panel of the information terminal E2 (step S22).

For example, it is assumed that the user U2 performs an evaluation on contents of the learning content with respect to the learning content reproduced by the information terminal E2 in step S22.

The information terminal E2 receives an evaluation content with respect to the learning content created by the user U2 as a user evaluation to be posted to the information processing system 10 (step S23). In the present example shown in the drawing, it is assumed that an evaluation result of the user U2 is a high evaluation. The information terminal E2 transmits the evaluation result (high evaluation) received in step S23 to the information processing system 10 (step S24).

The information processing system 10 accumulates the evaluation result (high evaluation) received in step S24 in the storage unit 27 (step S25). The information processing system 10 transmits the evaluation result (high evaluation) received in step S24 to the information terminal E1 of the user U1 (step S26).

The information terminal E1 displays the evaluation result (high evaluation) received in step S26 on the touch panel of the information terminal E1 (step S27).

### Processing of Information Terminal E1

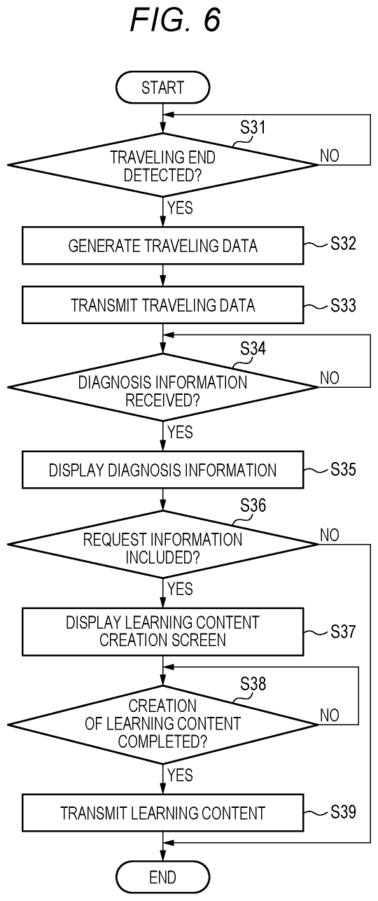

Next, an example of processing of the information terminal E1 in a case where the user U1 carries the information terminal E1 and drives the vehicle M1 will be described with reference to a flowchart shown in FIG. 6.

The information terminal E1 determines whether driving and traveling of the user U1 in the vehicle M1 end (step S31). Whether the driving and traveling end is determined based on, for example, whether the user U1 arrives at a destination input in advance before the start of traveling, as described at the beginning in FIG. 4. The arrival at the destination can be detected based on position information detected by the GPS sensor 33d and map information stored in the storage unit 35.

In step S31, when the driving and traveling do not end (step S31: No), the information terminal E1 repeats the process of step S31 and stands by until the driving and traveling end.

In step S31, when the driving and traveling end (step S31: Yes), the information terminal E1 generates the traveling data of the vehicle M1 based on the behavior data and the travel position data of the vehicle M1, that is, a traveling history of the driving (step S32). The behavior data is speed-up/slow-down, acceleration, steering conditions, vehicle speed, and the like of the vehicle M1 detected by the sensor unit 33 (the acceleration sensor 33a, the gyro sensor 33b, the speed sensor 33c, the GPS sensor 33d, and the like). The traveling position data is, for example, position coordinates of the vehicle M1 corresponding to the map information. This step S32 corresponds to step S11 in FIG. 4.

Next, the information terminal E1 transmits the generated traveling data of the vehicle M1 to the information processing system 10 (step S33). This step S33 corresponds to step S12 in FIG. 4.

Next, the information terminal E1 determines whether diagnosis information based on a result of a driving diagnosis process of the information processing system 10 with respect to the traveling data of the vehicle M1 transmitted in step S33 is received from the information processing system 10 (step S34).

In step S34, when no diagnosis information is received (step S34: No), the information terminal E1 repeats the process of step S34 and stands by until the diagnosis information is received.

In step S34, when the diagnosis information is received (step S34: Yes), the information terminal E1 displays a diagnosis result and the like in the diagnosis information on the touch panel of the information terminal E1 (step S35). This step S34 corresponds to step S15 in FIG. 4. The diagnosis result and the like displayed on the touch panel will be described later with reference to FIG. 10.

Next, the information terminal E1 determines whether the received diagnosis information includes a request information that requests creation of a learning content based on a specific event (step S36).

In step S36, when no request information is included (step S36: No), the information terminal E1 ends the process of the present example.

In step S36, when the request information is included (step S36: Yes), the information terminal E1 displays, on the touch panel of the information terminal E1, a creation screen for creating the learning content based on the specific event (step S37). The screen for creating the learning content will be described later with reference to FIG. 11.

Next, the information terminal E1 determines whether the creation of the learning content performed by the user U1 is completed (step S38).

In step S38, when the creation of the learning content is not completed (step S38: No), the information terminal E1 stands by until the creation is completed.

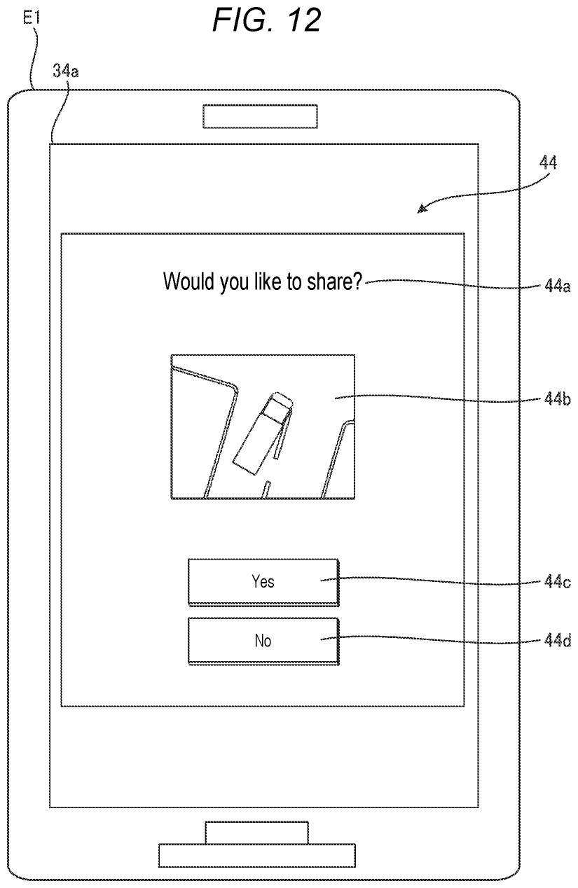

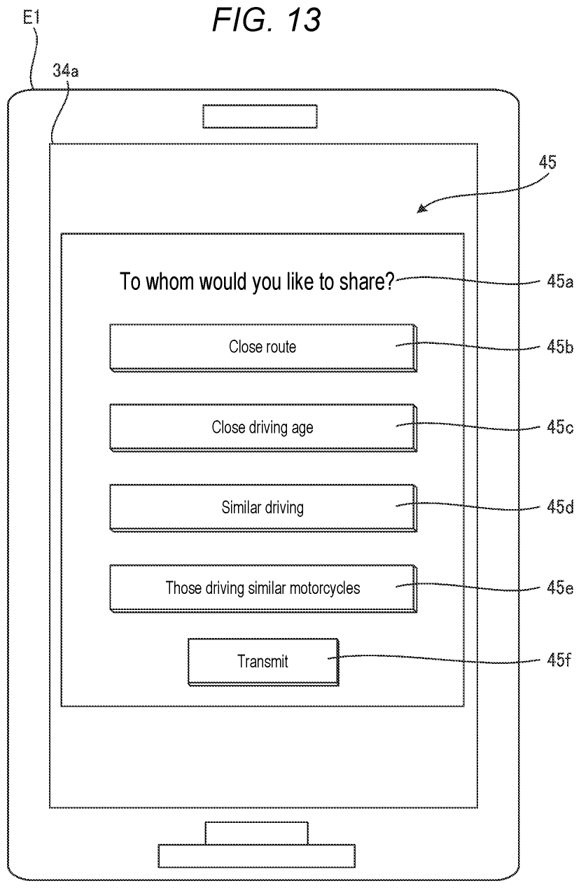

In step S38, when the creation of the learning content is completed (step S38: Yes), the information terminal E1 transmits the created learning content to the information processing system 10 (step S39). This step S39 corresponds to step S17 in FIG. 4. A screen operation when transmitting the learning content will be described later with reference to FIGS. 12 and 13.

Although illustration is omitted, when the information terminal E1 receives a predetermined evaluation result with respect to the transmitted learning content from another user (for example, the user U2 or U3) who views the learning content, the information terminal E1 displays the received evaluation result on the touch panel of the information terminal E1. The process of displaying the evaluation result corresponds to step S27 in FIG. 5.

### Driving Diagnosis Process of Information Processing System 10

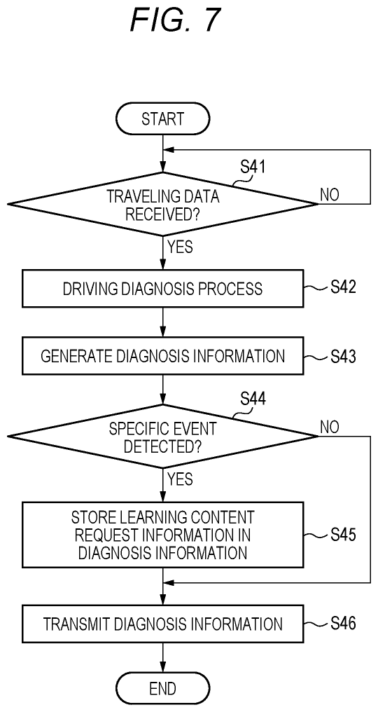

Next, an example of the driving diagnosis process of the information processing system 10 performed on the traveling data of the vehicle M1 generated by the information terminal E1 will be described with reference to a flowchart shown in FIG. 7.

The information processing system 10 determines whether traveling data of a vehicle generated by a predetermined information terminal is received (step S41). The predetermined information terminal is an information terminal (for example, information terminal E1, E2 or E3) registered by installing a predetermined application in advance.

In step S41, when no traveling data is received (step S41: No), the information processing system 10 repeats the process of step S41 and stands by until the traveling data is received.

In step S41, when the traveling data is received (step S41: Yes), the information processing system 10 causes the diagnosis processing unit 22 to perform the driving diagnosis process on driving of the user based on the received traveling data (step S42). In the present example shown in the drawing, a case in which the traveling data is received from the information terminal E1 of the user U1 who drives the vehicle M1 in step S41 will be described.

Next, the information processing system 10 generates diagnosis information based on a result of the driving diagnosis process (step S43). As described above, the diagnosis information includes, for example, distance and time over which the user U1 drives the vehicle M1, the number of times of sudden braking, the number of times of sudden starting, the number of times of sudden steering, the number of times of lane changing, maximum speed and average speed during traveling.

Next, the information processing system 10 determines whether a specific event is detected in the diagnosis information generated in step S43 (step S44). As described above, the specific event is an event including at least one of an event determined to be dangerous driving and an event determined to be driving for avoiding danger during the driving of the user U1.

In step S44, when the specific event is detected in the diagnosis information (step S44: Yes), the information processing system 10 stores the request information that requests the user U1 to create the learning content based on the specific event as a part of the diagnosis information in the diagnosis information generated in step S43 (step S45). The request information is stored, for example, as text information for the user U1 and as a request signal for the information terminal control unit 30 of the information terminal E1.

Next, the information processing system 10 transmits the diagnosis information generated in step S45 to the information terminal E1 of the user U1 (step S46).

On the other hand, in step S44, when no specific event is detected in the diagnosis information (step S44: No), the information processing system 10 proceeds to step S46 directly, and transmits the diagnosis information generated in step S43 to the information terminal E1 of the user U1.

Although not shown, when the user U1 creates the learning content in response to the transmitted diagnosis information and returns the created learning content, the information processing system 10 accumulates the returned learning content in the storage unit 27. The process of accumulating the learning content corresponds to step S18 in FIG. 4.

### Process of Providing Learning Content by Information Processing System 10

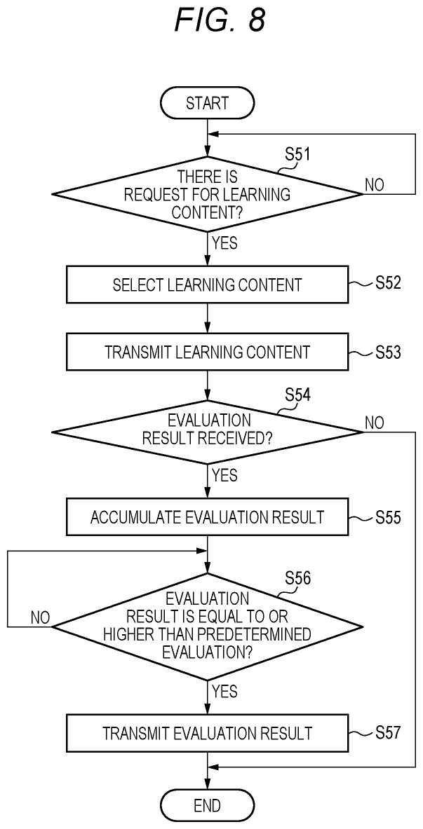

Next, an example of a process of providing the learning content performed by the information processing system 10 to share the accumulated learning content with a plurality of users will be described with reference to a flowchart shown in FIG. 8.

The information processing system 10 determines whether a request for a learning content is made from a predetermined information terminal (step S51). The predetermined information terminal is an information terminal (for example, information terminal E1, E2 or E3) registered by installing a predetermined application in advance. As described above with reference to FIG. 5, the request for the learning content means that, for example, the user U2 or the user U3 inputs the traveling destination to the information terminal E2 or E3 carried by the user U2 or the user U3 and the input information is transmitted from the information terminal E2 or E3 to the information processing system 10 before the user U2 or the user U3 starts driving the vehicle and traveling.

In step S51, when no request for the learning content is made (step S51: No), the information processing system 10 repeats the process of step S51 and stands by until a request for the learning content is made.

In step S51, when a request for the learning content is made (step S51: Yes), the information processing system 10 selects a learning content suitable for an owner (user) of the information terminal requesting the learning content from the learning contents accumulated in the storage unit 27 (step S52). The learning content suitable for the owner (user) of the information terminal is a learning content based on a specific event created relative to a route identical or similar to a traveling route toward a traveling destination of the user, a learning content created relative to a vehicle identical or similar to a vehicle of the user, a learning content created in association with a user whose driving tendency is identical or similar to a driving tendency of the user, or the like. In the present example shown in the drawing, a case where the request for the learning content is made from the information terminal E2 of the user U2 will be described. Therefore, the information processing system 10 selects a learning content suitable for the user U2 from the accumulated learning contents.

Next, the information processing system 10 transmits the learning content selected in step S52 to the information terminal E2 of the user U2 (step S53).

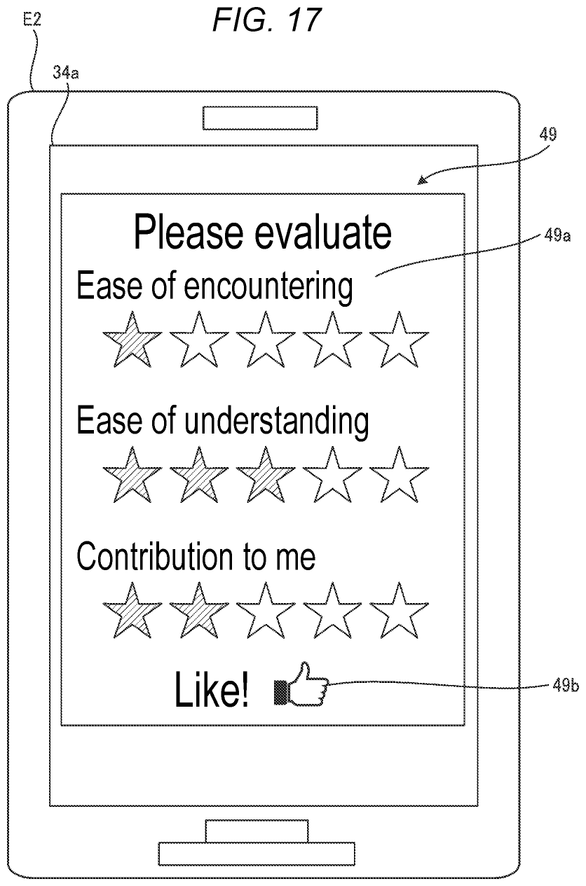

Next, the information processing system 10 determines whether an evaluation result of the user U2 with respect to the learning content transmitted in step S53 is received from the information terminal E2 (step S54). The evaluation result of the user with respect to the learning content will be described later with reference to FIG. 17.

In step S54, when no evaluation result is received (step S54: No), the information processing system 10 ends this provision process.

In step S54, when the evaluation result is received (step S54: Yes), the information processing system 10 accumulates the received evaluation result in the storage unit 27 (step S55). This step S54 corresponds to step S25 in FIG. 5.

Next, the information processing system 10 determines whether the received evaluation result is an evaluation result equal to or higher than a predetermined evaluation (step S56).

In step S56, when the evaluation result is not equal to or higher than the predetermined evaluation (step S56: No), the information processing system 10 repeats the determination of step S56 and stands by. When a predetermined time elapses during which no evaluation result equal to or higher than the predetermined evaluation can be received, the process of the present example is ended.

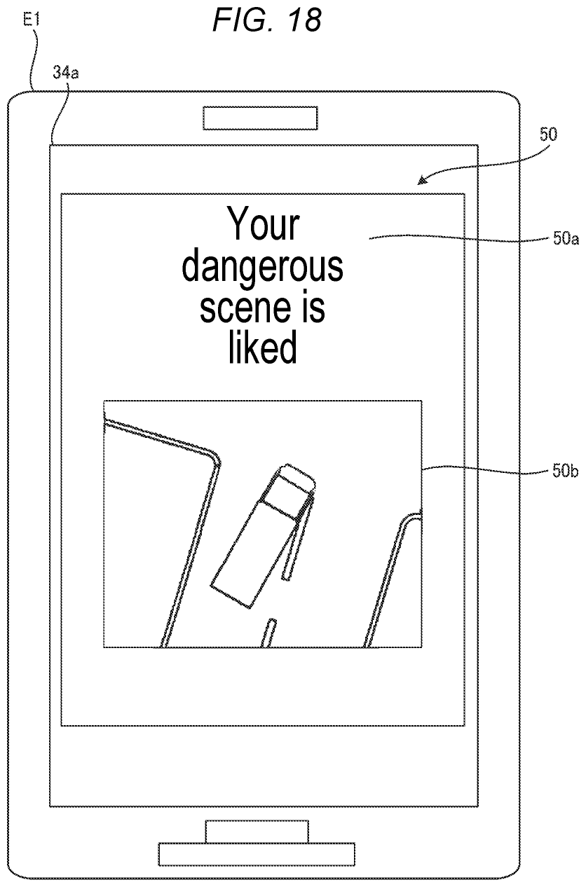

In step S56, when the evaluation result is equal to or higher than the predetermined evaluation (step S56: Yes), the information processing system 10 transmits the evaluation result to the information terminal of the creator of the learning content (step S57). For example, when the learning content transmitted to the information terminal E2 of the user U2 in step S53 is the learning content created by the user U1, the evaluation result of the user U2 is transmitted to the information terminal E1 of the user U1. This step S57 corresponds to step S26 in FIG. 5. The evaluation result transmitted to the information terminal of the creator will be described later with reference to FIG. 18.

### Screen Displayed on Information Terminal

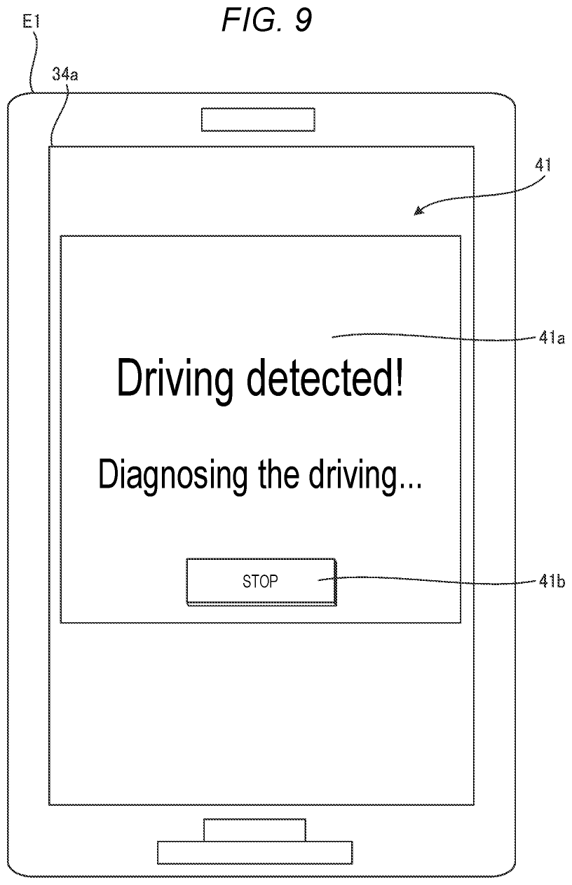

Next, an example of a display screen displayed on the touch panel of the information terminal in the processes of each unit shown in FIGS. 4 to 8 described above will be described with reference to FIGS. 9 to 18.

FIG. 9 is an example of a diagnosis standby screen 41 displayed on a touch panel 34a of the information terminal E1. The diagnosis standby screen 41 is a screen displayed on the touch panel 34a of the information terminal E1 during the driving diagnosis process of the information processing system 10 in step S13 shown in FIG. 4 and step S42 shown in FIG. 7.

As shown in FIG. 6, the information terminal E1 transmits the traveling data generated in step S32 to the information processing system 10 at the end of traveling (step S33). When the traveling data is transmitted, in the information processing system 10, the driving diagnosis process is performed on the traveling data (step S13 in FIG. 4 and step S42 in FIG. 7), and the information terminal E1 displays the diagnosis standby screen 41 on the touch panel 34a during a period in which the driving diagnosis process is performed, that is, during the process of step S34 in FIG. 6.

As shown in FIG. 9, the diagnosis standby screen 41 displays text information 41a notifying the user U1 that a driving content (traveling data) of the vehicle M1 driven by the user U1 is detected and the driving is diagnosed, such as “Driving detected! Diagnosing the driving . . . ” When it is not necessary to display a diagnosis result with respect to the driving, display of the diagnosis result can be stopped by touching a “stop” button 41b displayed on the diagnosis standby screen 41.

FIG. 10 is an example of a diagnosis information screen 42 displayed on the touch panel 34a of the information terminal E1. The diagnosis information screen 42 is a screen displayed on the touch panel 34a in the process of step S15 in FIG. 4 and the process of step S35 in FIG. 6.

In step S14 shown in FIG. 4 and step S34: Yes shown in FIG. 6, the information terminal E1 receives the diagnosis information with respect to the traveling data from the information processing system 10. The information terminal E1 displays the diagnosis information with respect to the received traveling data on the touch panel 34a.

As shown in FIG. 10, the diagnosis information screen 42 displays, as a diagnosis result 42a, information such as a traveling time “29 min” and a traveling distance “24 km” over which the user U1 drives the vehicle M1 during the current driving, and the number of times of ideal driving operations “Good for two times”. The diagnosis information screen 42 further displays request information 42b that requests the user U1 to create the learning content related to driving. For example, when the specific event (dangerous driving and danger avoidance driving) occurs during driving, request information that requests creation of a learning content based on the specific event is displayed. Specifically, when the fact that a G is detected during driving, for example, due to sudden braking or sudden starting, is determined as the specific event, text information such as “A big G occurred today. Would you like to post it if it was a near-miss experience?” is displayed to request creation of a learning content about what to be aware of by recalling conditions at that time. The diagnosis information screen 42 further displays a “Yes” button 42c and a “No” button 42d for selecting whether to post the near-miss experience in response to the request information 42b.

In the present example shown in FIG. 10, the diagnosis information displayed on the diagnosis information screen 42 is displayed as the text information, and the diagnosis information may also be displayed as an illustration or output as voice information.

FIG. 11 shows an example of a learning content creation screen 43 displayed on the touch panel 34a of the information terminal E1. The learning content creation screen 43 is a screen displayed on the touch panel 34a in the process of step S37 in FIG. 6.

As shown in FIG. 6, the information terminal E1 displays, on the touch panel 34a in step S35, the diagnosis result and the like in the diagnosis information received from the information processing system 10. An example of the diagnosis result and the like displayed on the touch panel 34a is the diagnosis information screen 42 shown in FIG. 10. The information terminal E1 displays the learning content creation screen 43 shown in FIG. 11 on the touch panel 34a when the user U1 presses the “Yes” button 42c on the diagnosis information screen 42 shown in FIG. 10 so as to post the near-miss experience in response to the request information 42b.

As shown in FIG. 11, the learning content creation screen 43 displays text information 43a such as “Create a dangerous scene using materials” as a message prompting the creation of the learning content. In response to this, the user U1 creates a learning content image 43b representing conditions under which dangerous driving (specific event) occurs on the touch panel 34a by using, for example, a paint tool in which parts such as a vehicle, an intersection, and a sign are prepared. A content of the learning content to be created is not limited to the image, and may also be, for example, a learning content in a question format in which text information is added to an image, or a learning content including only text information. The learning content creation screen 43 further displays a “Complete” button 43c to be pressed when the creation of the learning content is completed. A place where the user U1 creates the learning content is not limited to the touch panel 34a of the information terminal E1, and for example, the learning content may also be created by a personal computer and the created data may be transmitted to the information terminal E1.

FIG. 12 shows an example of a post selection screen 44 displayed on the touch panel 34a of the information terminal E1. The post selection screen 44 is a screen displayed on the touch panel 34a when the creation of the learning content is completed in the process of step S38 in FIG. 6 and the “Complete” button 43c on the learning content creation screen 43 in FIG. 11 is pressed by the user U1.

When the “Complete” button 43c on the learning content creation screen 43 in FIG. 11 is pressed, the information terminal E1 confirms with the user U1 whether the completed learning content (for example, the learning content image 43b) may be shared with a user other than the user U1. The information terminal E1 displays the post selection screen 44 on the touch panel 34a as a confirmation screen shown to the user U1.

As shown in FIG. 12, the post selection screen 44 displays text information 44a such as “Would you like to share?” asking whether the learning content may be shared with another user and a learning content image 44b created by the user U1. The post selection screen 44 further displays a “Yes” button 44c and a “No” button 44d for selecting whether to share or not.

FIG. 13 shows an example of a sharer selection screen 45 displayed on the touch panel 34a of the information terminal E1. The sharer selection screen 45 is a screen displayed on the touch panel 34a when the “Yes” button 44c for sharing the learning content is pressed on the post selection screen 44 in FIG. 12.

As shown in FIG. 13, the sharer selection screen 45 displays text information 45a such as “To whom would you like to share?” asking what kind of person (user) the user U1 would like to share the learning content with. Then, for example, selection buttons 45b to 45e indicating examples of user features are displayed. Specifically, the examples of the user features include a user who frequently travels along a route close to a traveling route of the user U1, which is indicated by the selection button 45b, a user whose driving age is close to that of the user U1, which is indicated by the selection button 45c, a user whose driving tendency is similar to that of the user U1, which is indicated by the selection button 45d, and a user who drives a motorcycle of the same type as that of the user U1, which is indicated by the selection button 45e. The user U1 selects a type of a user with whom the user U1 is willing to share the learning content created by the user U1 from the selection buttons 45b to 45e. A plurality of selection buttons may be selected. The sharer selection screen 45 further displays a transmission button 45f for transmitting the created learning content and the selected sharer to the information processing system 10.

When the transmission button 45f is pressed, the information terminal E1 transmits the created learning content and the selected sharer to the information processing system 10 in the process of step S17 in FIG. 4 and the process of step S39 in FIG. 6.

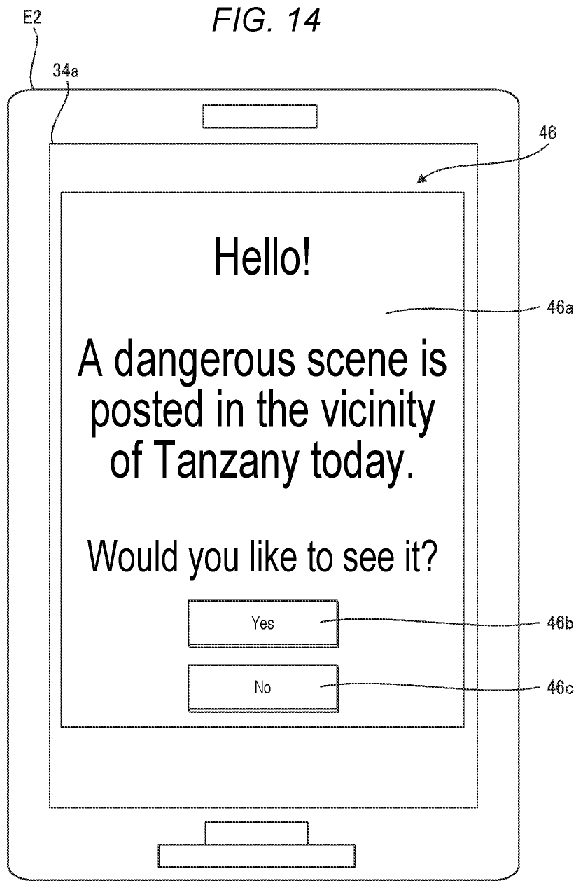

FIG. 14 is an example of a learning content introduction screen 46 displayed on the touch panel 34a of the information terminal E2. The learning content introduction screen 46 is an introduction screen displayed on the touch panel 34a before the learning content is displayed in the process of step S22 in FIG. 5 when the learning content is transmitted from the information processing system 10 to the information terminal E2 by the process of step S21 in FIG. 5 and the process of step S53 in FIG. 8.

In the process of step S52 in FIG. 8, the information processing system 10 selects the learning content to be provided to the user U2 from the learning contents accumulated in the storage unit 27. The information processing system 10 selects a predetermined learning content to be provided to the user U2 based on the sharer of the type selected by the user U1 on the sharer selection screen 45 in FIG. 13. The information processing system 10 transmits the selected learning content to the information terminal E2 in the process of step S21 in FIG. 5 and the process of step S53 in FIG. 8. In the process of step S22 in FIG. 5, the information terminal E2 displays the learning content introduction screen 46 before displaying the learning content received from the information processing system 10 on the touch panel 34a.

As shown in FIG. 14, the learning content introduction screen 46 displays text information 46a notifying that the learning content is posted, such as “Hello! A dangerous scene is posted in the vicinity of Tanzany (user U2) today. Would you like to see it?” The learning content introduction screen 46 further displays a “Yes” button 46b and a “No” button 46c for selecting whether to see or not.

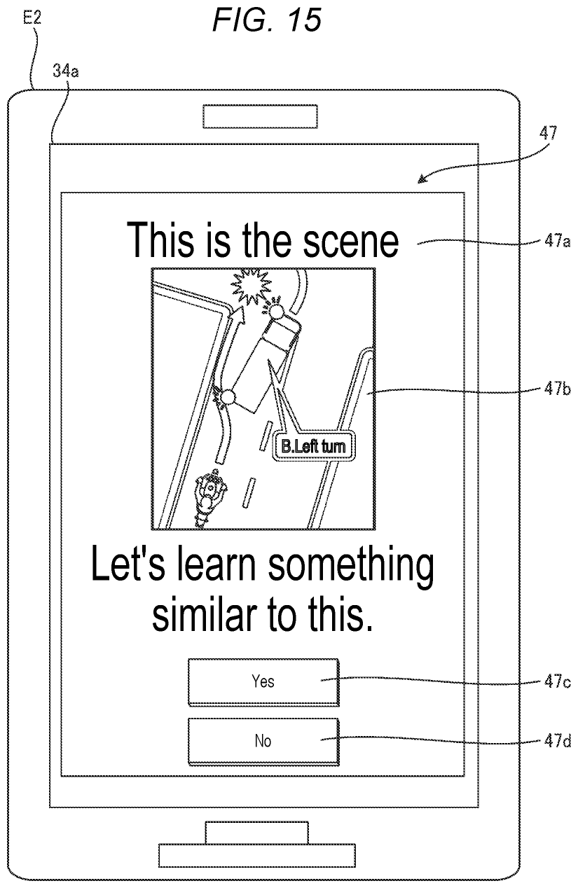

FIG. 15 shows an example of a posted content screen 47 displayed on the touch panel 34a of the information terminal E2. The posted content screen 47 is a screen displayed on the touch panel 34a when the user U2 presses the “Yes” button 46b on the learning content introduction screen 46 in FIG. 14.

When the “Yes” button 46b on the learning content introduction screen 46 in FIG. 14 is pressed, the information terminal E2 displays the learning content transmitted from the information processing system 10 to the information terminal E2 by the process of step S21 in FIG. 5 and the process of step S53 in FIG. 8 on the touch panel 34a as the posted content screen 47 in the process of step S22 in FIG. 5.

As shown in FIG. 15, the posted content screen 47 displays, for example, text information 47a encouraging learning about the posted content, such as “This is the scene. Let's learn something similar to this.” and a posted learning content image 47b. The posted content screen 47 further displays a “Yes” button 47c and a “No” button 47d for selecting whether to learn or not.

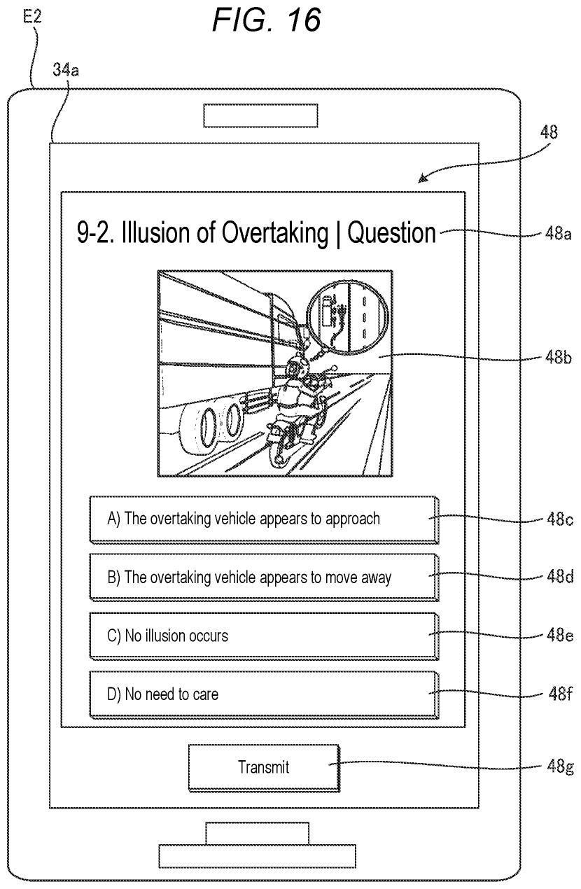

FIG. 16 shows an example of a learning screen 48 displayed on the touch panel 34a of the information terminal E2. The learning screen 48 is a screen displayed on the touch panel 34a when the user U2 presses the “Yes” button 47c on the posted content screen 47 in FIG. 15.

As shown in FIG. 16, the learning screen 48 display text information 48a indicating a learning question related to the learning content image 47b displayed on the touch panel 34a in FIG. 15, such as “What does the illusion of overtaking mean?”, and an overtaking image information 48b indicating an overtaking scene. Then, selection buttons 48c to 48f indicating choices of the question are displayed. Specific examples of the choices include “A) The overtaking vehicle appears to approach” shown in the selection button 48c, “B) The overtaking vehicle appears to move away” shown in the selection button 48d, “No illusion occurs” shown in the selection button 48e, and “No need to care” shown in the selection button 48f. The user U2 selects an answer to the question from the selection buttons 48c to 48f. The learning screen 48 further displays a transmission button 48g for transmitting the answer to the information processing system 10.

FIG. 17 shows an example of an evaluation screen 49 displayed on the touch panel 34a of the information terminal E2. The evaluation screen 49 is a screen displayed on the touch panel 34a when the user U2 presses the transmission button 48g on the learning screen 48 in FIG. 16.

As shown in FIG. 17, the evaluation screen 49 displays an evaluation item 49a requesting an evaluation of the user U2 with respect to the content learned in FIG. 16. As the evaluation item, for example, “ease of encountering example event”, “ease of understanding learning content”, and “contribution of learning content to me” are displayed. The evaluation screen 49 further displays a “Like!” button 49b.

The information terminal E2 receives an evaluation content created by the user U2 in the process of step S23 in FIG. 5. Then, in the process of step S24, the information terminal E2 transmits an evaluation result based on the received evaluation content to the information processing system 10.

FIG. 18 shows an example of an evaluation result screen 50 displayed on the touch panel 34a of the information terminal E1. The evaluation result screen 50 is a screen displayed on the touch panel 34a in the process of step S27 in FIG. 5.

The information processing system 10 selects a high evaluation result from evaluation results from other users with respect to the learning content posted by the user U1, and transmits the selected high evaluation result to the information terminal E1 in the process of step S26 in FIG. 5. The high evaluation result is, for example, an evaluation result in which an evaluation of three or more stars is acquired in the evaluation item shown on the evaluation screen 49 in FIG. 17.

In the process of step S27 in FIG. 5, the information terminal E1 displays the high evaluation result received from the information processing system 10 on the touch panel 34a as an evaluation result screen 50.

As shown in FIG. 18, the evaluation result screen 50 displays text information 50a indicating the evaluation result, such as “Your dangerous scene is liked” and a learning content image 50b posted by the user U1.

As described above, the information processing system 10 acquires the traveling data of the vehicle M1 from the information terminal E1 of the user U1 of the vehicle M1, performs the driving diagnosis process of the vehicle M1 based on the acquired traveling data, and transmits the diagnosis information based on the result of the driving diagnosis process to the information terminal E1 of the user U1. The diagnosis information includes the request information that requests the user U1 to create the learning content based on the specific event detected in the driving diagnosis process. The information processing system 10 receives the learning content created by the user U1 in response to the request information from the information terminal E1. According to this configuration, for example, it is possible to cause the user U1 who receives the diagnosis information to create the learning content based on the specific event while recalling the driving conditions related to the request information in the diagnosis information. Accordingly, since the user U1 can objectively view (additionally experience) an experience occurring to the user U1, a learning effect related to safe driving of the user U1 can be improved. In addition, by causing the user U1 to create the learning content via the information terminal E1, it is possible to reduce a content creation cost for a system provider. Further, by causing the user U1 to create the learning content, it is possible to improve acceptability (conviction) of other users (for example, the users U2 and U3) with respect to the created learning content.

In addition, the specific event detected in the driving diagnosis process is an event related to dangerous driving of the vehicle M1 or danger avoidance driving of the vehicle M1. The learning content requested for the user U1 is a content based on the specific event, that is, a content based on the event related to dangerous driving or danger avoidance driving of the vehicle M1. Therefore, by requesting the user U1 to generate two types of learning contents in different modes corresponding to a case where it is determined that dangerous driving is performed and a case where it is determined that dangerous preventive driving is performed, it is possible to promote a safe driving awareness behavior of the user U1.

In addition, the information processing system 10 transmits the learning content received from the information terminal E1 of the user U1 to, for example, the information terminal E2 of the user U2 different from the user U1 who creates the learning content. In this way, by sharing the learning content created by the user U1 with the other user U2, it is possible to improve motivation of each user to create the learning content.

In addition, the different user to which the learning content is transmitted is, for example, a user who is scheduled to travel by a vehicle along a route corresponding to the occurrence location of the specific event, a user on a vehicle whose type is identical or similar to that of the vehicle M1 of the user U1, a user whose driving tendency is identical or similar to that of the user U1, or the like. Therefore, the user who drives the vehicle can grasp the learning content related to dangerous driving or dangerous preventive driving in advance, and thus a learning effect of the user related to safe driving can be improved.

In addition, when the evaluation obtained from the user U2 different from the user U1 with respect to the learning content created by the user U1 is a high evaluation, the information processing system 10 transmits information based on the high evaluation to the information terminal E1 of the user U1. Accordingly, an evaluation such as “Like!” on the created learning content from others can be a reward for content creation of the user, which can increase motivation of the user to learn about safe driving.

Although the embodiment of the present disclosure is described above, the present disclosure is not limited to the above-described embodiment, and modifications, improvements, and the like can be made as appropriate.

For example, although the case where the information processing system 10 is provided in the external server ES is described in the above embodiment, the information processing system 10 is not limited thereto. For example, the information processing system 10 may be provided in the vehicle M1.

In addition, although the case where the information processing system 10 is implemented by a single device is described in the above embodiment, the information processing system 10 is not limited thereto. The information processing system 10 may be implemented by a plurality of devices. When the information processing system 10 is implemented by a single device, the content transmission unit 25 and the diagnosis information transmission unit 23 may be implemented as a single unit. When the information processing system 10 is implemented by a plurality of devices, the reception unit 24 and the content transmission unit 25 among the acquisition unit 21, the diagnosis processing unit 22, the diagnosis information transmission unit 23, the reception unit 24, and the content transmission unit 25 may be implemented as separate devices.

In addition, although the case where the information processing system 10 transmits the learning content to the information terminal E2 of the user U2 different from the user U1 when the learning content created by the user U1 is transmitted to the information processing system 10 is described in the above embodiment, the information processing system 10 is not limited thereto. For example, the information processing system 10 may transmit the learning content to the information terminal E1 of the user U1 who creates the learning content.

In addition, although the case where the vehicle M1 is a two-wheeled vehicle is described in the above embodiment, the vehicle M1 is not limited thereto. The vehicle M1 may be, for example, a three-wheeled automobile or a four-wheeled automobile.

In addition, although the acceleration sensor 33a, the gyro sensor 33b, the speed sensor 33c, the GPS sensor 33d, and the like are exemplified as the sensor unit 33 in the above embodiment, the sensor unit 33 is not limited thereto. For example, the sensor unit 33 may include an in-vehicle camera, a radar, and a light detection and ranging (LiDAR) mounted on the vehicle M1.

In addition, although the case where the user U1 carries the information terminal E1 and boards the vehicle M1 is described in the above embodiment, the information terminal E1 is not limited thereto. For example, the information terminal E1 may be carried in a vehicle (a three-wheeled vehicle or a four-wheeled vehicle) where the user boards.

The information processing method described in the above embodiment can be implemented by executing a prepared information processing program on a computer. The information processing program is recorded in a computer-readable storage medium and is executed by being read from the storage medium. The information processing program may further be provided in a form of being stored in a non-transitory storage medium such as a flash memory, or may be provided via a network such as the Internet. The computer that executes the information processing program may be provided in an information processing device, may be provided in an electronic device such as a smartphone, a tablet terminal, or a personal computer capable of communicating with the information processing device, or may be provided in a server device capable of communicating with the information processing device and the electronic device.

In addition, at least the following matters are described in the present specification. Although corresponding constituent elements or the like in the above embodiment are shown in parentheses, the present disclosure is not limited thereto.

(1) An information processing system (information processing system 10) including:
an acquisition processor (acquisition unit 21) configured to acquire traveling data of a vehicle (vehicle M1);
a diagnosis processor (diagnosis processor 22) configured to perform a driving diagnosis process of the vehicle based on the traveling data acquired by the acquisition processor;
a diagnosis information transmitter (diagnosis information transmission unit 23) configured to transmit, to an information terminal (information terminal E1) of a user (user U1) of the vehicle, diagnosis information based on a result of the driving diagnosis process performed by the diagnosis processor; and
a receiver (reception unit 24), in which
the diagnosis information includes request information that requests the user to create a learning content based on a specific event detected in the driving diagnosis process, and
the receiver receives the learning content created by the user in response to the request information from the information terminal.

According to (1), by causing the user to create the learning content, the user is enabled to objectively view (additionally experience) an own experience, and thus a learning effect related to safe driving can be improved. In addition, by causing the user to create the learning content, it is possible to reduce a content creation cost for a system provider and to improve acceptability (conviction) of users with respect to the learning content.

(2) The information processing system according to (1), in which
the specific event includes at least one of dangerous driving of the vehicle and danger avoidance driving of the vehicle.

According to (2), by generating the learning content corresponding to the specific event, for example, two types of contents in different modes corresponding to a case where it is determined that dangerous driving is performed and a case where it is determined that dangerous preventive driving is performed, it is possible to promote a safe driving awareness behavior of the user.

(3) The information processing system according to (1) or (2), in which
the acquisition processor, the diagnosis processor, the diagnosis information transmitter, and the receiver are provided in an external server (external server ES).

According to (3), in-vehicle resources can be simplified as compared with a configuration in which the acquisition processor, the diagnosis processor, the diagnosis information transmitter, and the receiver are mounted on the vehicle.

(4) The information processing system according to any one of (1) to (3), further including:
a content transmitter (content transmission unit 25) configured to transmit the learning content received by the receiver to an information terminal of a second user (users U2 and U3) different from a first user (user U1) who creates the learning content.

According to (4), by sharing the learning content created by the user with other users, it is possible to improve motivation to create the learning content.

(5) The information processing system according to (4), in which
the second user includes a user who is scheduled to travel by a vehicle along a route corresponding to an occurrence location of the specific event.

According to (5), since it is possible to grasp in advance whether there is any potential dangerous area along the traveling route, the learning effect of the user related to safe driving can be improved.

(6) The information processing system according to (4) or (5), in which
the second user includes a user of a vehicle whose type is identical or similar to that of a vehicle of the first user.

According to (6), since it is possible to grasp a dangerous event that occurs to a vehicle of the same or similar type, the learning effect of the user related to safe driving can be improved.

(7) The information processing system according to any one of (4) to (6), in which
the second user includes a user whose driving tendency is identical or similar to that of the first user.

According to (7), since it is possible to grasp a dangerous event that occurs to a user having the same or similar driving tendency, the learning effect of the user related to safe driving can be improved.

(8) The information processing system according to any one of (4) to (7), further including:
an evaluation transmitter (evaluation transmission unit 26) configured to transmit, when an evaluation obtained from a user different from the first user with respect to the learning content satisfies a predetermined condition, information based on the evaluation to an information terminal of the first user.

According to (8), an evaluation such as “Like!” on the generated content from others becomes a reward for content creation of the user, which further improves motivation of the user to learn about safe driving.

(9) An information terminal carried by a user of a vehicle, including:
a receiver (reception unit 32) configured to receive diagnosis information based on a result of a driving diagnosis process of the vehicle from an information processing system; and
a transmitter (transmission unit 31), in which
the diagnosis information includes request information that requests the user to create a learning content based on a specific event detected in the driving diagnosis process, and
the transmitter transmits the learning content created by the user in response to the request information to the information processing system.

According to (9), by causing the user to create the learning content, the user is enabled to objectively view (additionally experience) an own experience, and thus a learning effect related to safe driving can be improved. In addition, by causing the user to create the learning content, it is possible to reduce a content creation cost for a system provider and to improve acceptability (conviction) of users with respect to the learning content.

(10) An information processing method using an information terminal carried by a user of a vehicle and an information processing system, in which
the information processing system performs a driving diagnosis process of the vehicle based on traveling data of the vehicle, and transmits diagnosis information based on a result of the driving diagnosis process to the information terminal,
the information terminal receives the diagnosis information,
the diagnosis information includes request information that requests the user to create a learning content based on a specific event detected in the driving diagnosis process, and
the information terminal transmits the learning content created by the user in response to the request information to the information processing system.

According to (10), by causing the user to create the learning content, the user is enabled to objectively view (additionally experience) an own experience, and thus a learning effect related to safe driving can be improved. In addition, by causing the user to create the learning content, it is possible to reduce a content creation cost for a system provider and to improve acceptability (conviction) of users with respect to the learning content.

(11) A non-transitory computer-readable recording medium storing an information processing program for causing a computer of an information processing system to execute a process, the process including:
acquiring traveling data of a vehicle;
performing a driving diagnosis process of the vehicle based on the traveling data;
transmitting, to an information terminal of a user of the vehicle, diagnosis information based on a result of the driving diagnosis process; and
receiving, in which
the diagnosis information includes request information that requests the user to create a learning content based on a specific event detected in the driving diagnosis process, and
the receiving includes receiving the learning content created by the user in response to the request information from the information terminal.

According to (11), by causing the user to create the learning content, the user is enabled to objectively view (additionally experience) an own experience, and thus a learning effect related to safe driving can be improved. In addition, by causing the user to create the learning content, it is possible to reduce a content creation cost for a system provider and to improve acceptability (conviction) of users with respect to the learning content.

(12) A non-transitory computer-readable recording medium storing an information processing program for causing a computer of an information terminal carried by a user of a vehicle to execute a process, the process including:
receiving diagnosis information based on a result of a driving diagnosis process of the vehicle from an information processing system; and
transmitting information to the information processing system, in which
the diagnosis information includes request information that requests the user to create a learning content based on a specific event detected in the driving diagnosis process, and
the transmitting includes transmitting the learning content created by the user in response to the request information to the information processing system.

According to (12), by causing the user to create the learning content, the user is enabled to objectively view (additionally experience) an own experience, and thus a learning effect related to safe driving can be improved. In addition, by causing the user to create the learning content, it is possible to reduce a content creation cost for a system provider and to improve acceptability (conviction) of users with respect to the learning content.

1. An information processing system comprising:
an acquisition processor configured to acquire traveling data of a vehicle;
a diagnosis processor configured to perform a driving diagnosis process of the vehicle based on the traveling data acquired by the acquisition processor;
a diagnosis information transmitter configured to transmit, to an information terminal of a user of the vehicle, diagnosis information based on a result of the driving diagnosis process performed by the diagnosis processor; and
a receiver, wherein
the diagnosis information includes request information that requests the user to create a learning content based on a specific event detected in the driving diagnosis process, and
the receiver receives the learning content created by the user in response to the request information from the information terminal.

2. The information processing system according to claim 1, wherein
the specific event includes at least one of dangerous driving of the vehicle and danger avoidance driving of the vehicle.

3. The information processing system according to claim 1, wherein
the acquisition processor, the diagnosis processor, the diagnosis information transmitter, and the receiver are provided in an external server.

4. The information processing system according to claim 1, further comprising:
a content transmitter configured to transmit the learning content received by the receiver to an information terminal of a second user different from a first user who creates the learning content.

5. The information processing system according to claim 4, wherein
the second user includes a user who is scheduled to travel by a vehicle along a route corresponding to an occurrence location of the specific event.

6. The information processing system according to claim 4, wherein
the second user includes a user of a vehicle whose type is identical or similar to that of a vehicle of the first user.

7. The information processing system according to claim 4, wherein
the second user includes a user whose driving tendency is identical or similar to that of the first user.

8. The information processing system according to claim 4, further comprising:
an evaluation transmitter configured to transmit, when an evaluation obtained from a user different from the first user with respect to the learning content satisfies a predetermined condition, information based on the evaluation to an information terminal of the first user.

9. An information terminal carried by a user of a vehicle, comprising:
a receiver configured to receive diagnosis information based on a result of a driving diagnosis process of the vehicle from an information processing system; and
a transmitter, wherein
the diagnosis information includes request information that requests the user to create a learning content based on a specific event detected in the driving diagnosis process, and
the transmitter transmits the learning content created by the user in response to the request information to the information processing system.

10. An information processing method using an information terminal carried by a user of a vehicle and an information processing system, comprising:
performing, by the information processing system, a driving diagnosis process of the vehicle based on traveling data of the vehicle, and transmits diagnosis information based on a result of the driving diagnosis process to the information terminal; and
receiving, by the information terminal, the diagnosis information, wherein
the diagnosis information includes request information that requests the user to create a learning content based on a specific event detected in the driving diagnosis process, and
the information terminal transmits the learning content created by the user in response to the request information to the information processing system.

11. A non-transitory computer-readable recording medium storing an information processing program for causing a computer of an information processing system to execute a process, the process comprising:
acquiring traveling data of a vehicle;
performing a driving diagnosis process of the vehicle based on the traveling data;
transmitting, to an information terminal of a user of the vehicle, diagnosis information based on a result of the driving diagnosis process; and
receiving, wherein
the diagnosis information includes request information that requests the user to create a learning content based on a specific event detected in the driving diagnosis process, and
the receiving includes receiving the learning content created by the user in response to the request information from the information terminal.

12. A non-transitory computer-readable recording medium storing an information processing program for causing a computer of an information terminal carried by a user of a vehicle to execute a process, the process comprising:
receiving diagnosis information based on a result of a driving diagnosis process of the vehicle from an information processing system; and
transmitting information to the information processing system, wherein
the diagnosis information includes request information that requests the user to create a learning content based on a specific event detected in the driving diagnosis process, and
the transmitting includes transmitting the learning content created by the user in response to the request information to the information processing system.
